(19) United States
(12) Patent Application Publication
(10) Pub. No.: US 2003/0110023 A1
(43) Pub. Date: Jun. 12, 2003

(54) Systems and methods for translating languages

(76) Inventors: Srinivas Bangalore, Hackettstown, NJ (US); Giuseppe Riccardi, Hoboken, NJ (US)

Correspondence Address: Samuel H. Dworetsky, AT&T CORP., P.O. Box 4110, Middletown, NJ, 07748-4110, US

(21) Appl. No.: 10/217,882

(22) Filed: Aug. 13, 2002

Related U.S. Application Data
(60) Provisional application No. 60/337,908, filed on Dec. 7, 2001.

(51) Int. Cl. G06F 17/28

(52) U.S. Cl. 704/5

(57) ABSTRACT

Systems and methods for translating one language to another language. A consensus translation system directs a transcription or other input to be translated by other translation systems. The outputs of those translation systems are aligned and the aligned translations are divided into segments. Each segment includes a segment translation from each of the translation outputs. The consensus translation of the transcription is constructed by selecting the majority segment translation from each segment. When there is no clear majority segment translation, the majority segment translation is selected at random or is aided by another selection criteria such as a language model.

### RELATED APPLICATIONS

This application claims the benefit of U.S. Provisional Patent Application Serial No. 60/337,908, entitled “Method and Approach for Combining Translations from Multiple Translation Systems,” filed Dec. 7, 2001, which is incorporated herein by reference.

### BACKGROUND OF THE INVENTION

1. The Field of the Invention

The present invention relates to systems and methods for translating languages. More particularly, the present invention relates to systems and methods for determining a consensus translation that is derived from the translations produced by other translation systems.

2. Background and Relevant Art

Translating one language to another language has never been an easy task. Human translators indicate that it is important to have grammatical skills and a good vocabulary in both the source and destination languages. It is also beneficial if the human translator is experienced with the subject matter of the translation. This type of knowledge is important because each language typically has unique sentence structures, idiomatic expressions, and other aspects that are ambiguous from a translation perspective.

In machine translations, where a computer or other machine performs the translation, translating one language to another language becomes an even more complex task even though the linguistic complexities are often transparent to users. The complexities of machine translation, in addition to the actual translation, often expand to include voice recognition and transcription.

Each machine translation system will also experience translation problems that are related to the particular translation method employed by that translation system. Typical machine translation systems include, for instance, direct translation systems, transfer-based translation systems, and interlingua-based translation systems. Each translation system can also be approached from different perspectives. Some translation systems employ a rule-based approach, while other translation systems use an example-based approach, a statistical approach or some combination of these approaches. Much time has been spent in developing the translation systems available today, but experience has shown that most translation systems are far from perfect and translation errors frequently occur.

While each translation system typically has various strengths, each translation system also has various limitations or weaknesses. Example-based translation systems generally produce a good translation when the input translation matches an existing example. The quality of the output declines, however, when the input does not match an example. Clearly, an extremely large database would be required to store all possible examples. Rule-based systems often perform adequately when a particular situation satisfies some rule. Unfortunately, there are often multiple exceptions to every rule and rules are not constant across languages. In addition, translation systems have to account for words and phrases whose meanings are often dependent on context and sentence structure.

In spite of these difficulties, translation systems are very valuable from various perspectives. When faced with a choice, for example, consumers usually prefer to converse in their native language rather than struggle with a foreign language that they may only partially understand. People will also prefer to read their native language whenever possible as they are usually able to obtain a greater understanding of the text.

Machine translation systems also have an economic advantage. Translating one language to another language requires significant skill and can be quite costly when performed by a human translator. The cost is measured not only in money, but also in time as human translators are only able to translate at a limited rate. The disadvantages of human translators can be overcome by machine translation systems that can translate at a much faster rate and can be implemented in, for example, voice recognition systems. The primary problem with machine translation systems, however, is ensuring that the translation is correct, a task that proves to be extremely difficult for machine translation systems.

### BRIEF SUMMARY OF EMBODIMENTS OF THE INVENTION

These and other limitations are overcome by the present invention which is directed to systems and methods for translating one language to another language by a “consensus translation,” which is constructed from the translations produced by other translation systems. This approach takes advantage of the fact that the translation errors of one translation system are not related to the translation errors of the other translation systems. Thus, the outputs of the multiple translation systems can be processed to identify or determine a consensus translation, which is more accurate than that of the individual translation systems.

In one embodiment, the consensus translation is determined by first directing a transcription to various translation systems. A consensus translation is then extracted or constructed from the individual translations received from the various translation systems. The consensus translation is constructed, for example, by aligning the individual translations with respect to each other. Preferably, this alignment arranges the translations into segments, and then identifies common sub-strings or segment translations among the various translations. Aligning the translations also identifies those sub-strings or segments that are not common to the various translations.

After the translations have been aligned, they are organized into related groups of segments. For example, each segment may contain the various translations generated for a particular word or phrase from the original transcription. A “segment translation” is then selected from each segment to determine the consensus translation of the transcription. For example, a segment translation can be determined by selecting the translation that occurs most often in that particular segment. In the event that there is not a majority consensus, a segment translation can be selected based upon an alternative selection criteria, such as a language model.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary spoken dialog system that utilizes consensus translation modules;

FIG. 2A generally illustrates a consensus translation system that translates speech/text input to speech/text output;

FIG. 2B is a block diagram of a consensus translation system including a consensus translation module that determines a consensus translation from the outputs of multiple translation systems;

FIG. 2C is a block diagram that illustrates a consensus translation system that translates transcriptions from multiple sources;

FIG. 3 further illustrates a consensus translation module that determines a consensus translation of a transcription; and

FIG. 4 illustrates a lattice structure that may be used in determining a consensus translation.

### DETAILED DESCRIPTION OF THE PREFERRED EMBODIMENTS

Translating one language to another language is often achieved using some type of machine or computer translation system. Translation systems range from interlingua-based translation systems and transfer-based translation systems to direct translation systems, each of which has various strengths and weaknesses. Embodiments of the present invention use a consensus translation system that identifies a consensus translation based on the translation output of other traditional translation systems.

One advantage of the present invention is that the number of errors in the consensus translation is reduced by combining the strengths of other translation systems. In other words, the errors committed by a particular translation system are unlikely to be repeated in another translation system. Because the translation systems are independent, the consensus translation system is able to generate consensus translations that are typically better than the translation of any given translation system in both subjective and objective terms.

Translating one language to another language usually begins by receiving the source material to be translated from a source. The source material often takes the form of either speech or text. When the source material is speech, the consensus translation system described herein may utilize speech recognition systems that are often able to convert the speech to a suitable format, such as text. After the input has been converted to the appropriate form, it is translated and the output is often in the same format as the input. Text is often preferred because it can be readily interpreted by humans. In some instances, the text is converted to speech by a text-to-speech module. The consensus translation system described herein can thus be incorporated with spoken dialog systems and may be associated with any of the various modules in such systems. The consensus translation system may be associated with an automatic speech recognition module, a spoken language understanding module, a dialog manager, and/or a text-to-speech module.

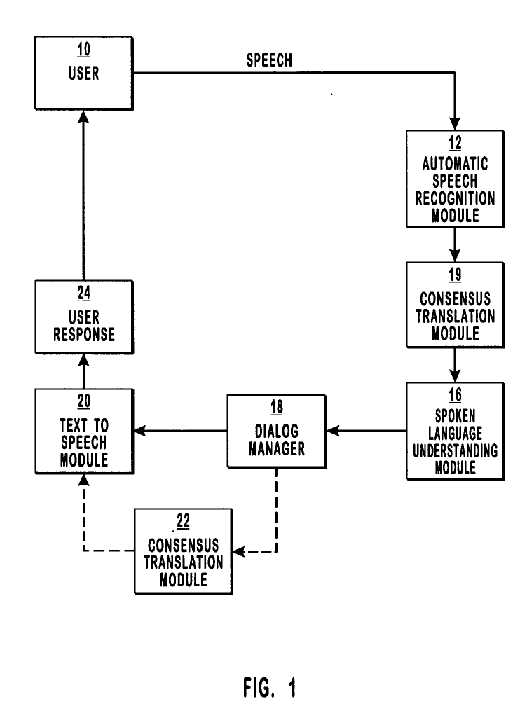

For example, FIG. 1 illustrates a spoken dialog system that utilizes a consensus translation module or system. A user 10 speaks in a language such as Spanish. An automatic speech recognition module 12 recognizes the speech of the user 10 and produces a transcription of the speech. The consensus translation module 19 translates the transcription into English (or other language(s)) and transmits the translation of the transcription to the spoken language understanding module 16.

The dialog manager 18 and the text-to-speech module 20 then prepare a response to the user 10 as is known in the art. In this example, the user response 24 is in English. However, another consensus translation module 22 could be inserted between the text to speech module 20 and the dialog manager 18 such that the user response 24 is in Spanish, the same language originally spoken by the user 10.

In this manner, the principles of the present invention can enhance Multilanguage spoken dialog systems. As mentioned above, the consensus translation module may be inserted or associated with any of the components of the spoken dialog system. In addition to spoken dialog systems, customer service centers, for example, can utilize the consensus translation system in resolving customer concerns. A consensus translation system can also be implemented on the Internet or other computer network, where a user simply desires to translate the text of one language to another language.

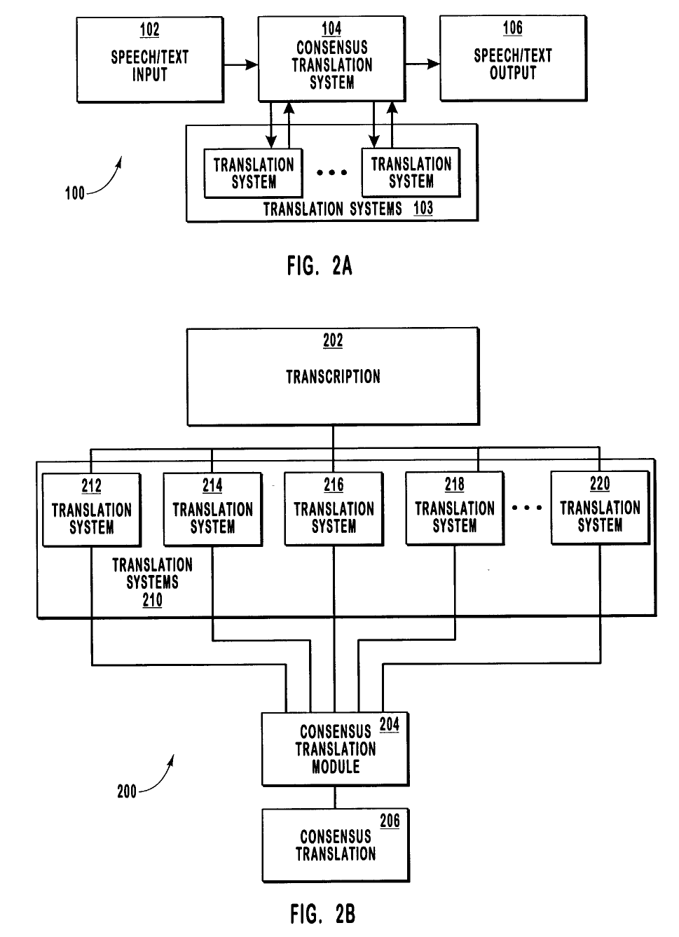

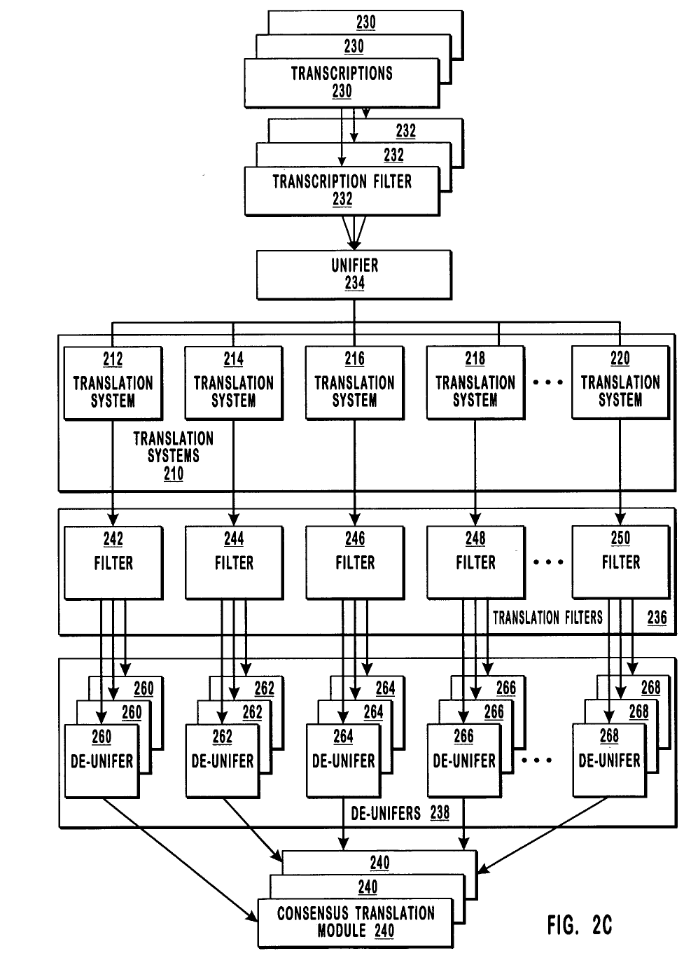

FIG. 2A is a block diagram that generally illustrates one presently preferred embodiment of a consensus translation system, designated generally as 100. In this example, a consensus translation system 104 receives speech/text input 102, such as a transcription or text. The consensus translation system 104 then directs the speech/text input 102 to other independent translation systems 103. The translation system 104 receives the translations generated by the other translation systems 103 and determines or constructs a consensus translation of the input 102 from those independent translations. Finally, the consensus translation system 104 produces or generates the speech/text output 106, which is the consensus translation. While the present invention is described in terms of text/speech, it is understood that the present invention extends to other forms of input. The term “transcription” is intended to represent all forms of speech/text input 102 or other source material.

FIG. 2B illustrates in further detail one example of a consensus translation system for translating a transcription from one language to another language. The transcription 202 is directed to and translated by one or more independent translation systems 210. For example, in the illustrated embodiment, the transcription 202 is translated independently by each of the translation systems 212, 214, 216, 218, and 220. The output translation of each translation system 212, 214, 216, 218, and 220 is then received by the consensus translation module 204.

In general, the consensus translation module 204 combines the output of the translation systems 210 to determine a consensus translation. Identification of a consensus translation is performed, for example, by comparing each of the translation outputs of the translation systems 210. The consensus translation module 204, by combining the outputs of the translation systems, improves the accuracy of the resulting consensus translation. In addition, the consensus methodology can be applied to other areas including, but not limited to, part of speech tagging, text categorization, speech recognition, and the like or any combination thereof.

In the illustrated embodiment, generation of a consensus translation 206 is performed by the consensus translation module 204. In this example, the consensus translation 206 usually takes the form of text. The text, however, can be converted to speech using a text-to-speech module. When the consensus translation system 200 is used, for instance, in the context of customer service, then the transcription 202 corresponds to speech received from a user or customer and the output 206 corresponds to the response of the system, which is in the form of speech. Converting the input speech to text and the output text to speech is usually performed by other modules as the consensus translation system typically receives and generates text.

FIG. 2C expands the consensus translation system of FIG. 2B. In particular, FIG. 2C illustrates that embodiments of the consensus translation system can be used for more than one input or transcription 230. In other words, the consensus translation system can translate transcriptions that originate from different entities or sources at the same time. In this example, the transcription filters 232 are used to normalize the transcriptions 230. The transcriptions 230 are often generated from speech and therefore contain elements that may interfere with the translation. Disfluencies such as truncated words, filled pauses such as “uh”, and the like may be included in the transcription. The transcription filters 232 normalize the transcriptions 230 by removing these types of disfluencies. A unifier 234 performs the task of ensuring that repetitions of the same sentence or string are not sent to the translation systems 210. The unifier 234 thus correlates the transcriptions 230 to the appropriate entities or sources that have submitted transcriptions for translation without causing the translation systems 210 to perform repetitive translations. This is done to ensure that the entity or person that submitted a transcription for translation receives the consensus translation of that transcription while minimizing the work performed by the consensus translation system.

The translation filters 236 normalize the outputs of the translation systems 210. Non ASCII characters, for example, are removed or normalized. The translation filters 236 effectively clean the text received from the translation systems 210. The unification performed by the unifier 234 is reversed by the de-unfiers 238 in order to correlate the outputs of the translation systems with the original transcriptions 230. This ensures that each source receives a consensus translation of the transcriptions that were translated by the consensus translation system. The consensus translation module 240 then determines or generates consensus translations for the transcriptions 230. The de-unifiers 238 may also operate after a consensus translation is constructed.

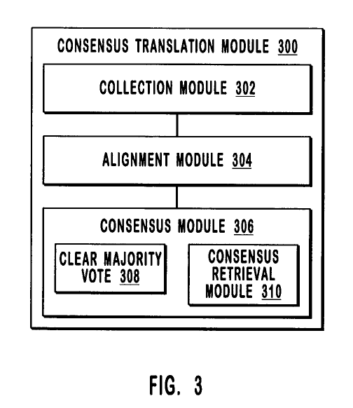

FIG. 3 provides additional details regarding the implementation of one embodiment of the consensus translation module 300. The consensus translation module 300 first receives the independent translations of one or more independent translation systems with a collection module 302. The number of translation systems that provide output to the collection module 302 can vary and is not restricted to any particular number. Typically, at least two translation systems provide output to the collection module 302 of the consensus translation module 300.

The outputs produced by the translation systems are next processed by the consensus translation module 300. The outputs of the various translation systems are aligned by the alignment module 304 into segments before the consensus translation is identified or constructed. The alignment module 304 creates a representation of the translated transcription that identifies those segments of the various translations received from the translation systems that are common or similar.

Aligning one output with another output involves defining a profile that records or identifies the insertions, deletions, and substitution of tokens (words) that are required to transform one output into the other output. The number of insertions, deletions, and substitutions is often referred to as an “edit distance.” When multiple outputs or strings are involved, one method for aligning multiple strings is a progressive multiple alignment.

In a progressive multiple alignment involving N translation outputs, the edit distances and the corresponding profiles for each of the N(N−1)/2 pairs of translation outputs are determined. Next, the following steps are repeated until one profile remains. First, a profile is selected for the output-output pair, the output-profile pair, and the profile-profile pair. Then, the edit distance between the selected profile and the remaining translation outputs and profiles are computed.

Consider the following example, with reference to FIGS. 2B, 2C, 3, and 4, where the consensus translation system is translating the phrase “give me driving directions please to Middletown area” from English to Spanish. The outputs or translations, respectively, of the translation systems 212, 214, 216, 218, and 220 are as follows:

deme direcciones impulsoras por favor a area de Middletown;

deme direcciones por favor a area;

deme direcciones conductors por favor al area Middletown;

deme las direcciones que conducen satisfacen al area de Middletown; and

deme que las direcciones tendencia agradan al area de Middletown.

Aligning these translations as described above results in the following alignment table that is arranged in segments where each segment contains a segment translation for a word or phrase of the original transcription.

| | | | | | | | |
|---|---|---|---|---|---|---|---|
| Deme | | direcciones | impulsoras | favor | a | area | de Middletown |
| | | | por | | | | |
| Deme | | direcciones | por | favor | a | area | |
| Deme | | direcciones | conductors | favor | a | area | Middletown |
| | | | por | | | | |
| Deme | las | direcciones | que conducen | satisfacen | al | area | de Middletown |
| Deme | que | direcciones | tendencia | agradan | al | area | de Middletown |
| | las | | | | | | |

As illustrated in the above alignment, there are certain segments that contain segment translations where the various translation systems agree on both the word and the order of the words. All translation systems, in this example, agree on the words or segment translations “deme,” “direcciones,” and “area” in different segments. Similarly, there are certain segments where the segment translations generated by the translation systems have little or no agreement. Thus, portions of each independent translation are aligned with corresponding portions of the other independent translations received from the various translation systems.

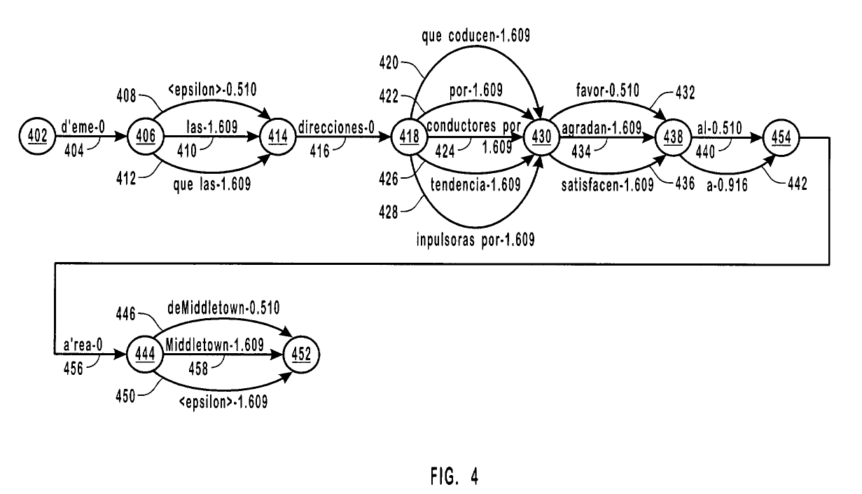

FIG. 4 illustrates a lattice structure 400 that corresponds to the multiple alignment illustrated in the alignment table. The lattice points (shown as points 402, 406, 414, 418, 430, 438, 544, 552, and 554) define segments that contain different segment translations for a string, word or phrase. The segment translations or portions of an independent translation within a particular segment are assigned a score that is used in constructing the consensus translation. In this example, the score corresponds to weights that are assigned to each segment translation. Thus, the arcs between lattice points represent the word phrases (which may be empty) and their associated weights are illustrated in FIG. 4.

The weight associated with a particular arc is, in this example, the negative logarithm of the probability of the word or phrase. Thus, if all of the translation systems agree on a particular word, phrase or segment, then the arc has a zero weight. The number of arcs that exist between lattice points are representative of the agreement or disagreement in translation among the various translation systems. Thus, the arcs 420, 422, 424, 426, and 428 between the lattice points 418 and 430 indicate that there is significant disagreement on the translation of the transcription among the various translation systems.

Referring back to FIG. 3, determining the consensus translation can be achieved using a clear majority vote (308). This is typically performed by selecting the segment translation in each segment that has the lowest score or the most votes. The majority segment translation is the arc with the lowest score and has the majority vote for a particular segment. In other words, the majority segment translation is the segment translation that occurs most often in the segment. When there is no clear majority segment translation of a particular segment, then the consensus translation for that segment is often selected arbitrarily or randomly.

Using the clear majority vote 308 in this example, the consensus translation of the phrase “give me driving directions please to Middletown area” is determined by selecting the arc with the lowest score. Only the arc 404 exists between the lattice points 402 and 406 and “deme” is the selected segment translation for this segment. Between the lattice points 406 and 414, the arc 408, which is empty, is selected. Between the lattice points 414 and 418, the arc 416 is the only arc and the consensus segment translation for this segment is “direcciones.”

Between the lattice points 418 and 430, each of the arcs 420, 422, 424, 426, and 428 have the same score. The selected translation is thus ad hoc for this segment. Between the lattice points 430 and 438, the arc 432 has the lowest score and the selected translation for this segment is “favor.” Using a similar process, the selected translation for the segment between the lattice points 438 and 454 is “al,” the selected translation for the segment between the lattice points 454 and 452 is “area” and the selected translation for the segment between the lattice points 444 and 452 is “de Middletown.”

The resulting consensus translation for the phrase “give me driving directions please to Middletown area” is “deme direcciones por favor al area de Middletown.”Using the clear majority vote 308, the consensus translation selected for the segment between the lattice points 418 and 430 will vary depending on which word is selected. Thus, the consensus translation has a substantially equal chance of being, for example, “deme direcciones conductores por favor al area de Middletown.” Each of the segment translations for the segment between the lattice points 418 and 430 has an essentially equal chance of being selected as the consensus segment translation for that segment. In this case, the consensus translation for the segment between the lattice points 418 and 430 may be randomly selected.

The clear majority vote 308 can be augmented with additional decision-making criteria. For example, in the illustrated embodiment, it is augmented with a consensus retrieval module 310. The consensus retrieval module 310 adds a language model, such as a posterior n-gram language model, to the clear majority vote 308. The consensus retrieval 310 selects those translations that best fit the n-gram context as provided by the language model. The selected translation is then dependent on the language model.

The present invention thus extends to both systems and methods for translating a transcription from one language to another. The embodiments of the present invention may comprise a special purpose or general purpose computer including various computer hardware, as discussed in greater detail below.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions include, for example, instructions and data which cause a general purpose computer, special purpose computer, or special purpose processing device to perform a certain function or group of functions. Computer-executable instructions also include program modules which are executed by computers in stand alone or network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those skilled in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for translating a transcription in a first language to a second language, the method comprising:
receiving an independent translation of the transcription into the second language from one or more translation systems;
aligning each independent translation into one or more segments, wherein each segment includes a segment translation from each of the independent translations received from the one or more translation systems; and
determining a consensus translation of the transcription by selecting a segment translation from each of the one or more segments.

2. A method as defined in claim 1, wherein receiving an independent translation into the second language of the transcription from one or more translation systems further comprises directing the transcription to the one or more translation systems.

3. A method as defined in claim 1, wherein receiving an independent translation into the second language of the transcription from one or more translation systems further comprises normalizing the translations received from the one or more translation systems.

4. A method as defined in claim 1, wherein aligning each independent translation into one or more segments further comprises:
identifying common segment translations between the aligned translations; and
placing common segment translations in the same segment.

5. A method as defined in claim 1, wherein aligning each independent translation into one or more segments further comprises assigning a score for each segment translation, wherein the scores of the segment translations within a segment identify a majority segment translation for that segment.

6. A method as defined in claim 5, wherein determining a consensus translation of the transcription further comprises selecting the majority segment translation from each segment.

7. A method as defined in claim 6, further comprising randomly selecting a segment translation from a segment when a majority segment translation cannot be selected from that segment.

8. A method as defined in claim 6, further comprising selecting a segment translation for a segment by combining the scores of the segment translations with a language model.

9. A method as defined in claim 1, wherein aligning the translations received from the one or more translation systems further comprises aligning the translations using a progressive multiple alignment.

10. A consensus translation module for use in translating a transcription from one language to another language, the consensus translation module comprising:
a collection module that receives translation outputs from one or more independent translation systems;
an alignment module that aligns the translation outputs into segments, wherein each segment contains a segment translation from each translation output, wherein each segment translation has a score that is used to determine a majority segment translation within each segment; and
a consensus module for constructing a consensus translation by selecting the majority segment translation of each segment, wherein the consensus module uses a consensus retrieval module to select a segment translation for a particular segment when a majority segment translation cannot be selected for the particular segment.

11. A consensus translation module as defined in claim 10, wherein the collection module further comprises a filter that normalizes the translation outputs of the one or more independent translation systems.

12. A consensus translation module as defined in claim 10, wherein the alignment module aligns the translation outputs using progressive multiple alignment.

13. A consensus translation module as defined in claim 12, wherein the alignment module identifies common segments of the translation outputs.

14. A consensus translation module as defined in claim 10, wherein the consensus retrieval module combines a score for a segment translation with a language model to select the segment translation of a particular segment.

15. A consensus translation module as defined in claim 14, wherein the consensus module uses the consensus retrieval module to select a segment translation when a majority segment translation cannot be identified.

16. A method for translating a transcription from one language to another language, the method comprising:
receiving the transcription from a source;
filtering the transcription to remove disfluencies from the transcription;
directing the transcription to one or more translation systems;
receiving independent translation outputs of the transcription from the translation systems;
aligning the translation outputs into a segment structure, wherein each segment contains a segment translation from each translation output;
for each segment, determining a majority segment translation from the segment translations in each segment; and
constructing a consensus translation by combining the majority segment translations from each segment.

17. A method as defined in claim 16, wherein receiving the transcription from a source further comprises receiving additional transcriptions from additional sources.

18. A method as defined in claim 16, further comprising:
filtering the additional transcriptions;
unifying the additional transcriptions such that redundant transcriptions are not directed to the one or more translation systems;
normalizing the translation outputs of the one or more translation systems for the additional transcriptions; and
de-unifying the translation outputs such that the consensus translations correspond to the additional transcriptions.

19. A method as defined in claim 16, wherein receiving translation outputs of the transcription from the translation systems further comprises normalizing the translation outputs.

20. A method as defined in claim 16, wherein aligning the translation outputs into a segment structure further comprises performing a progressive multiple alignment on the translation outputs.

21. A method as defined in claim 16, wherein determining a majority segment translation from the segment translations in each segment further comprises:
for each segment, assigning a score to each segment translation, wherein the scores identify a majority segment translation; and
when the scores do not identify the majority segment translation, combining the scores of the segment translations with a language model to identify the majority segment translation for each segment.

22. A computer program product for implementing a method for translating a transcription from one language to another language, the computer program product comprising:
a computer-readable medium having computer-readable instructions for performing the method, the method comprising:
receiving a translation of the transcription from one or more independent translation systems, wherein each translation system translates the transcription independently of the other translation systems;
aligning the translations received from the one or more independent translation systems into one or more segments and each segment includes one or more segment translations from the translations of the translation systems; and
determining a consensus translation of the transcription by selecting a segment translation from each segment of the aligned translations.

23. A computer program product as defined in claim 22, wherein receiving a translation of the transcription from at least one or more translation systems further comprising normalizing the translations received from the translation systems.

24. A computer program product as defined in claim 22, wherein aligning the translations received from the one or more independent translation systems further comprises assigning a score for each segment translation, wherein the scores of the segment translations within a segment identify a majority segment translation for that segment.

25. A computer program product as defined in claim 24, wherein determining a consensus translation of the transcription further comprises selecting the majority segment translation from each segment.

26. A computer program product as defined in claim 25, further comprising randomly selecting a segment translation from a segment when a majority segment translation cannot be selected from that segment.

27. A computer program product as defined in claim 26, further comprising selecting a segment translation for a segment by combining the scores of the segment translations with a language model.

28. A computer program product as defined in claim 22, wherein aligning the translations received from the one or more independent translation systems comprises aligning the translations using a progressive multiple alignment.

29. A method of translating a transcription from a first language to a second language, the method comprising:
receiving an independent translation into the second language from each translation system of a plurality of translation systems;
aligning portions of each independent translation that correspond to portions of the other independent translations from the plurality of translation systems into segments;
assigning a score for each independent translation portion within a segment according to a comparison of each independent translation portion within the segment; and
determining a consensus translation by selecting segments according to scores of the independent translation portions within each segment.

30. A method as defined in claim 29, wherein receiving an independent translation into the second language from each translation system of a plurality of translation systems further comprises normalizing the independent translations.

31. A method as defined in claim 29, wherein aligning portions of each independent translation that correspond to portions of the other independent translations further comprises:
identifying common portions among the independent translations; and
placing common portions in the same segment.

32. A method as defined in claim 29, wherein aligning portions of each independent translation that correspond to portions of the other independent translations further comprises aligning the portions of the independent translations using a progressive multiple alignment.
